(19) United States
(12) Patent Application Publication
(10) Pub. No.: US 2018/0203597 A1
(43) Pub. Date: Jul. 19, 2018

(54) USER TERMINAL DEVICE AND CONTROL METHOD THEREFOR

(71) Applicant: SAMSUNG ELECTRONICS CO., LTD., Suwon-si, Gyeonggi-do (KR)

(72) Inventors: Seung-hyun LEE, Iksan-si, Jeollabuk-do (KR); Young-hyun KIM, Gunpo-si, Gyeonggi-do (KR); Won-yong KIM, Seoul (KR); Jeong-yi PARK, Suwon-si, Gyeonggi-do (KR); Bo-ra HYUN, Hwaseong-si, Gyeonggi-do (KR)

(21) Appl. No.: 15/744,311

(22) PCT Filed: Jul. 5, 2016
(86) PCT No.: PCT/KR2016/007210

§ 371 Date: Jan. 12, 2018

(30) Foreign Application Priority Data
Aug. 7, 2015 (KR) 10-2015-0111707

(51) Int. Cl. G06F 3/0488; H04M 1/725; G06F 3/0354; G06F 3/0484

(52) U.S. Cl. CPC G06F 3/04883; H04M 1/72519; H04M 2250/22; G06F 3/04842; G06F 3/03545

(57) ABSTRACT

A user terminal device is provided. The user terminal device includes: a touch display configured to display a screen; and a controller configured to execute a function of an application corresponding to a touch gesture having a predetermined pattern using a content included in a selected region when the touch gesture is received in a state in which a partial region on the screen is selected.

### TECHNICAL FIELD

Apparatuses and methods consistent with the present disclosure relates to a user terminal device and a control method therefor, and more particularly, to a user terminal device capable of automatically executing a function of an application depending on a gesture of a user input to the user terminal device, and a control method therefor.

### BACKGROUND ART

Most of modern mobile apparatuses such as smartphones, and the like, provide a touch interface sensing a manipulation of a user touching a displayed screen.

A user terminal device according to the related art has required to perform manipulations and menu selections several times to input information displayed on one screen to other function.

For example, in the case in which a user is to search a wondering content of contents of an article displayed on the screen of the user terminal device, the user should select a desired content of the contents of the article, perform a manipulation for displaying an additional function menu on the screen, select a copy item of the menu, execute a web browser to move to a site providing a search service, and perform an input for pasting a copied content to a search window.

The procedures as described above are very troublesome in terms of a user that uses a user terminal device in which only a touch manipulation is possible.

Meanwhile, the user terminal device may sense a touch of a stylus pen. The stylus pen enables the user to perform fine, accurate, and various touch manipulations.

However, a stylus pen according to the related art has been used only to perform a touch manipulation using a finger, for example, a touch of a screen keyboard, in addition to the purpose of writing or drawing a picture by hand, and extension of a function using the stylus pen has been restrictive.

### DISCLOSURE

### Technical Problem

The present disclosure provides a user terminal device capable of automatically executing a function of an application depending on a gesture of a user input to the user terminal device, and a control method therefor.

### Technical Solution

According to an aspect of the present disclosure, a user terminal device includes: a touch display configured to display a screen; and a controller configured to execute a function of an application corresponding to a touch gesture having a predetermined pattern using a content included in a selected region when the touch gesture is received in a state in which a partial region on the screen is selected.

The selection for the partial region and the touch gesture may be performed by a stylus pen.

A type of the content may include at least one of an image and a text included in the selected region.

The controller may decide a type of content usable for executing the function of the application, extract the decided type of content from the selected region, and execute the function of the application corresponding to the touch gesture using the extracted content.

The controller may extract a content required for executing the function of the application among contents included in the selected region and execute the function of the application corresponding to the touch gesture using the extracted content.

The controller may analyze an image included in the selected region to extract an object included in the image, and execute the function of the application corresponding to the touch gesture using the extracted object.

The user terminal device may further include a storage configured to store a plurality of patterns and information on functions of applications corresponding to each of the plurality of patterns, wherein the controller decides a pattern matched to the received touch gesture among the plurality of patterns and executes a function of an application corresponding to the matched pattern using the content.

The controller may display a user interface (UI) screen for registering a pattern, match a pattern input on the UI screen to a function of an application selected by a user, and store the matched pattern in the storage.

According to another aspect of the present disclosure, a control method for a user terminal device including a touch display displaying a screen includes: receiving a touch gesture having a predetermined pattern in a state in which a partial region on the screen is selected; and executing a function of an application corresponding to the touch gesture using a content included in the selected region.

The selection for the partial region and the touch gesture may be performed by a stylus pen.

A type of the content may include at least one of an image and a text included in the selected region.

The executing may include: deciding a type of content usable for executing the function of the application; extracting the decided type of content from the selected region; and executing the function of the application corresponding to the touch gesture using the extracted content.

The executing may include: extracting a content required for executing the function of the application among contents included in the selected region; and executing the function of the application corresponding to the touch gesture using the extracted content.

The executing may include: analyzing an image included in the selected region to extract an object included in the image; and executing the function of the application corresponding to the touch gesture using the extracted object.

The control method may further include pre-storing a plurality of patterns and information on functions of applications corresponding to each of the plurality of patterns, wherein the executing includes: deciding a pattern matched to the received touch gesture among the plurality of patterns; and executing a function of an application corresponding to the matched pattern using the content.

The pre-storing may include displaying a UI screen for registering a pattern; and matching a pattern input on the UI screen to a function of an application selected by a user and storing the matched pattern.

### Advantageous Effects

According to the diverse exemplary embodiments of the present disclosure, the user may easily execute a function that he/she frequently uses only by inputting a gesture corresponding to the user terminal device.

In addition, the user may easily input required information displayed on the screen to a specific application.

In addition, the user terminal device may deliver user-friendly analog sensitivity by realizing digilog technology in which the stylus pen is not simply a touch tool, but has a function of a classic pen drawing a gesture.

### DESCRIPTION OF DRAWINGS

FIG. 1 is a block diagram illustrating schematic components of a user terminal device according to an exemplary embodiment of the present disclosure;

FIG. 2 is a block diagram illustrating detailed components of the user terminal device of FIG. 1;

FIGS. 3A to 3E are views for describing an operation of posting a content on a social network service (SNS) according to an exemplary embodiment of the present disclosure;

FIGS. 4A to 4C are views for describing an operation of searching a content according to an exemplary embodiment of the present disclosure;

FIGS. 5A and 5B are views for describing an operation of transmitting a content by a messenger according to an exemplary embodiment of the present disclosure;

FIG. 6 is a view for describing a content selecting method according to an exemplary embodiment of the present disclosure;

FIGS. 7A and 7B are views for describing an example of inputting portions of a content to an application according to an exemplary embodiment of the present disclosure;

FIGS. 8A to 8G are views illustrating a set screen according to an exemplary embodiment of the present disclosure; and

FIG. 9 is a flow chart for describing a control method for a user terminal device according to an exemplary embodiment of the present disclosure.

### BEST MODE

Hereinafter, exemplary embodiments of the present disclosure will be described in more detail with reference to the accompanying drawings. In describing the present disclosure, when it is decided that a detailed description for the known functions or configurations related to the present disclosure may unnecessarily obscure the gist of the present disclosure, the detailed description therefor will be omitted.

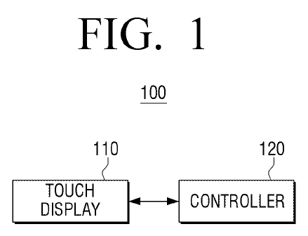

FIG. 1 is a block diagram illustrating schematic components of a user terminal device according to an exemplary embodiment of the present disclosure.

Referring to FIG. 1, the user terminal device 100 includes a touch display 110 and a controller 120.

The touch display 110 displays a screen. In detail, the touch display 110, which is a visual output device of the user terminal device 100, may display a screen visually representing information.

In addition, the touch display 110 senses a touch. In detail, the touch display 110 may sense a touch on the screen. The touch display 110 may sense a touch of a user. The touch indicates a manipulation of the user touching a surface of the touch display 110. The touch may be performed by a portion of a user's body, for example, a finger. In addition, the touch may be performed by a tool through which the touch display 110 may sense the touch, such as a stylus pen.

Although not specifically illustrated, the touch display 110 may be a device in which a display unit for displaying a screen and a sensor unit for sensing the touch are combined with each other. In this case, the touch display 110 may include various display units such as a liquid crystal display (LCD) panel, a plasma display panel (PDP), an organic light emitting diode (OLED), a vacuum fluorescent display (VFD), a field emission display (FED), an electro luminescence display (ELD), and the like. In addition, the touch display 110 may include a capacitive or resistive touch sensor. The capacitive touch sensor uses a manner of calculating a coordinate of a touched point by sensing micro electricity excited to a touched portion when a portion of the user's body or a touch tool touches the surface of the touch display 110, using a dielectric coated on the surface of the touch display 110. The resistive touch sensor includes two electrode plates and uses a manner of calculating a coordinate of a touched point by sensing a current flowing due to a contact between upper and lower electrode plates at the touched point in the case in which the user touches a screen.

Additionally, the touch display 110 may further include a proximity sensor. The proximity sensor is a sensor for sensing a motion of approaching the touch display 110 without being in direct contact with the surface of the touch display 110. The proximity sensor may be implemented by various types of sensors such as a high frequency oscillation type sensor forming a high frequency magnetic field to sense a current induced by magnetic field characteristics changed at the time of approaching an object, a magnetic sensor using a magnet, and a capacitive sensor sensing a capacitance changed due to approach of a target.

The controller 120 controls the respective components of the user terminal device 100. In detail, the controller 120 may control the respective components configuring the user terminal device 100 to perform operations and functions of the user terminal device 100.

The controller 120 may perform image processing for outputting a screen to the touch display 110. In addition, the controller 120 may receive a signal sensing the touch on the touch display 100. Here, the controller 120 may recognize a touch point using a coordinate transferred through a touch signal. Therefore, the controller 120 may receive a manipulation of the user input through the touch display 110.

The controller 120 may receive an input selecting a partial region on the screen. In detail, the controller 120 may receive an input selecting one region of the displayed screen depending on a manipulation of the user touched on the screen. The user may select a partial region on the screen in various manners. For example, when a touch dragging the screen is input, the controller 120 may decide that a rectangular region having a displacement from a start point at which the touch of the drag starts to an end point at which the touch is released as a diagonal line is a selected region. Alternatively, the controller 120 may decide that a region closed by a curved line that the user draws on the screen is a selected region.

The controller 120 enters a selection state in response to the selection input of the user. The selection state is a state in which the partial region on the output screen is selected. The controller 120 may represent the selected region in the selection state in various manners. For example, the controller 120 may display dotted lines along a boundary of the selected region. Alternatively, the controller 120 may shadow the remaining region that is not selected to darkly display the remaining region.

The controller 120 receives a touch gesture of a predetermined pattern. In detail, the controller 120 may receive a touch gesture performing a touch depending on the predetermined pattern. Here, the pattern indicates features that sameness of specific figures, symbols, letters, or the like may be recognized when the user again inputs the specific figures, symbols, letters, or the like. The controller 120 may recognize handwriting that the user touches on the screen using the pattern. For example, the pattern may be at least one of a trend line, the number of strokes, and an abstracted shape.

The controller 120 may decide whether or not the signal of the received touch gesture is the gesture depending on the predetermined pattern. When the touch gesture depending on the predetermined pattern is received, the controller 120 executes a function of an application corresponding to the touch gesture using a content included in the selected region.

Here, the content indicates all information displayed on the screen. For example, the content includes a text and an image visually output on the screen. In addition, the content may be a screen shot image generated by capturing an output of the screen as a screen shot as it is. Information that is not viewed, such as a sound, an address, a path, and the like, related to a page displayed on the screen may also be included in the content.

In detail, when it is decided that the touch gesture is the gesture depending on the predetermined pattern, the controller 120 may extract the content included in the selected region. Here, the controller 120 may selectively extract the content in the region. A selection reference for extracting the content may be changed depending on a function of an application that is to be executed.

In an exemplary embodiment, the controller 120 may decide a type of content usable for executing the function of the application, extract the decided type of content from the selected region, and execute the function of the application corresponding to the touch gesture using the extracted content. In other words, when a kind of content usable for the function of the application corresponding to the touch gesture is only a text type of content, the controller 120 may extract only a text of an image and a text mixed with each other in the selected region.

In another exemplary embodiment, the controller 120 may extract a content required for executing the function of the application among contents included in the selected region and execute the function of the application corresponding to the touch gesture using the extracted content. As an example, in the case in which information required for the function of the application corresponding to the touch gesture is a classification ‘phone number’, the controller 120 may extract a content in which numerals are arranged in a predetermined format as a phone number from the selected region, and input the extracted numerals to a number input blank of a dialing function.

In another exemplar embodiment, the controller 120 may analyze an image included in the selected region to extract an object included in the image, and execute the function of the application corresponding to the touch gesture using the extracted object. As an example, the controller 120 may identify one object or a plurality of objects configuring the image through signal processing of the image included in the selected region. For example, in the case in which a photograph is included in the selected region, the controller 120 may distinguish a person, a background, and the surrounding props from each other. In addition, the controller 120 may input the extracted person in the photograph to an application having a person search function.

The controller 120 extracts a content required for executing the function of the application among contents included in the selected region and executes the function of the application corresponding to the touch gesture using the extracted content. In detail, the controller 120 may decide the function of the application corresponding to the touch gesture. The controller 120 may decide which pattern of gesture the received touch gesture is, and decide to which function of the application the decided pattern of gesture corresponds.

Here, the function of the application means a function of software installed in the user terminal device 100. Software serving as an operating system (OS) is installed in the user terminal device 100, and the installed operating system may include several functions for revealing a capability of hardware of the user terminal device 100. In addition, an application program, which is software for performing a special-purpose function, may be additionally installed in the user terminal device 100, and the installed application program may have several functions for realizing its object. For example, a ‘copy to clipboard’ function of temporarily storing data that are to be copied in a storage region of a main memory may be included as a function of the operating system. A function of posting a message on a social media (or a social network service (SNS) may be included as the function of the application program.

The controller 120 may include a central processing unit (CPU), a read only memory (ROM) in which a control program for controlling the user terminal device 100 is stored, and a random access memory (RAM) storing signals or data input from the outside of the user terminal device 100 or used as a memory region for processes performed by the user terminal device 100. The CPU may be at least one of a single core processor, a dual core processor, a triple core processor, and a quad core processor. The CPU, the ROM, and the RAM may be connected to each other through internal buses.

The user terminal device 100 as described above may input information and execute a desired function of the application, at a time only by a gesture input of the user in information on the screen that is being searched.

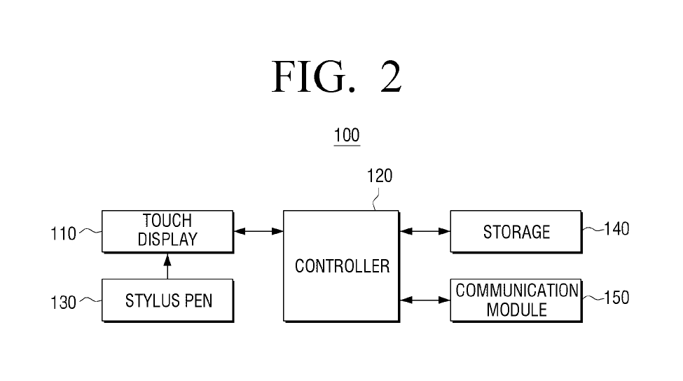

FIG. 2 is a block diagram illustrating detailed components of the user terminal device of FIG. 1.

Referring to FIG. 2, the user terminal device 100 includes the touch display 110, the controller 120, a stylus pen 130, a storage 140, and a communication module 150. Here, an operation and a configuration of the touch display 110 are the same as those of the touch display 110 of FIG. 1, and a detailed description therefor will thus be omitted.

The stylus pen 130 is a tool for touching the touch display 110 to perform a touch input. The user may hold the stylus pen 130 instead of a portion of his/her body and then perform a user manipulation touching the touch display 110.

The stylus pen 130 may be configured in a passive touch manner and an active touch manner depending on a manner of the touch sensor of the touch display 110. In addition, the stylus pen 130 may include an electrical circuit component for transferring information on wiring pressure that uses a pen. In addition, in the case in which a plurality of stylus pens are touched, the stylus pen 130 may include a component transmitting signals capable of distinguishing the touched pens from each other.

The storage 140 stores a plurality of patterns and information on functions of applications corresponding to each of the plurality of patterns. In detail, the storage 140 may store a plurality of patterns for recognizing the received touch gesture. The storage 140 may store information on functions of applications corresponding to each of a plurality of registered patterns. The storage 140 may store information in which the patterns and the functions of the applications correspond to each other in a lookup table form.

The storage 140 may be implemented by a storage medium in the user terminal device 100 and an external storage medium, for example, a removable disk including a universal serial bus (USB) memory, a web server through a network, or the like. Although the RAM or the ROM used to store and perform the control program is described as a component of the controller 120 in the present disclosure, it may be implemented as a component of the storage 140.

The storage 140 may include a ROM, a RAM, or a memory card (for example, a secure digital (SD) card or a memory stick) that may be detached/mounted from/in the user terminal device 100. In addition, the storage 140 may include a non-volatile memory, a volatile memory, a hard disk drive (HDD), or a solid state drive (SSD).

The communication module 150 performs communication. In detail, the communication module 150 may perform communication with an external apparatus in various communication manners. The communication module 150 may be connected to an Internet network to communicate with at least one external server. The communication module 150 may perform direct communication with another device disposed at an adjacent distance. The communication module 150 may perform various wired and wireless communication. The communication module 150 may perform communication according to wireless communication standards such as near field communication (NFC), Bluetooth, wireless fidelity (WiFi), and code division multiple access (CDMA).

The controller 120 controls the respective components. A description for an operation of the controller 120 controlling the touch display 110 is the same as that of FIG. 1, and an overlapping description will thus be omitted.

The controller 120 may identify a touch by the stylus pen 130. In detail, the controller 120 may identify a touch input by the stylus pen 130 different from a touch by a human body, or the like.

The controller 120 may decide a pattern matched to the received touch gesture among the plurality of patterns stored in the storage 140, and execute a function of an application corresponding to the matched pattern using a content included in a selected region.

The controller 120 may control required communication while executing the function of the application. For example, the controller 120 may control an access to a server supporting a search function for executing the search function. The controller 120 may control an access to a server supporting a messenger service for executing a content transfer function.

The user terminal device 100 as described above may input information and execute a desired function of the application, at a time only by a gesture input of the user in information on the screen that is being searched. In addition, the gesture input by the stylus pen 130 may extend usefulness of the stylus pen while giving the user a feeling as if the user draws a picture with the pen.

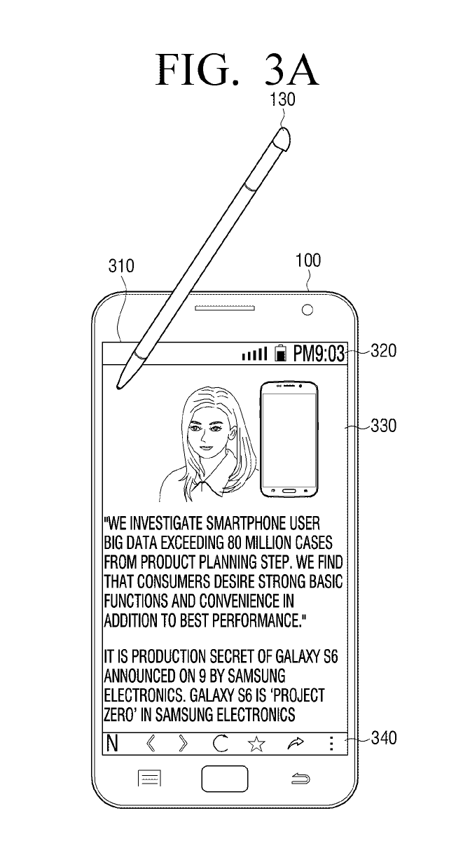

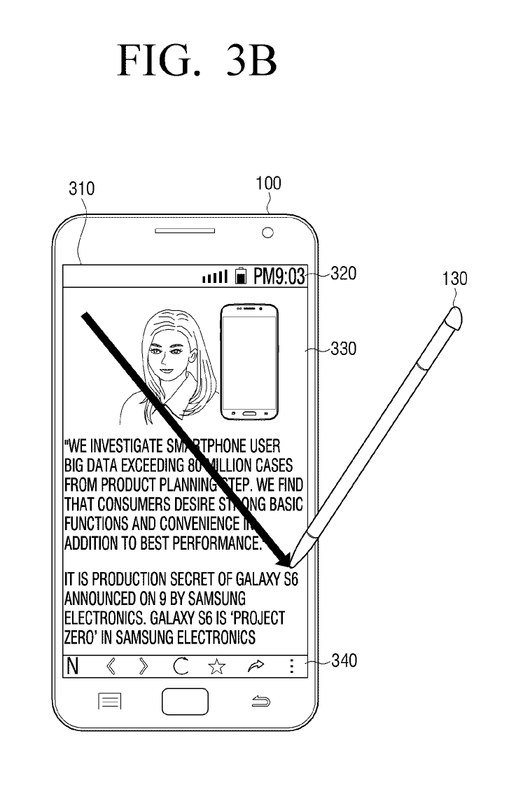

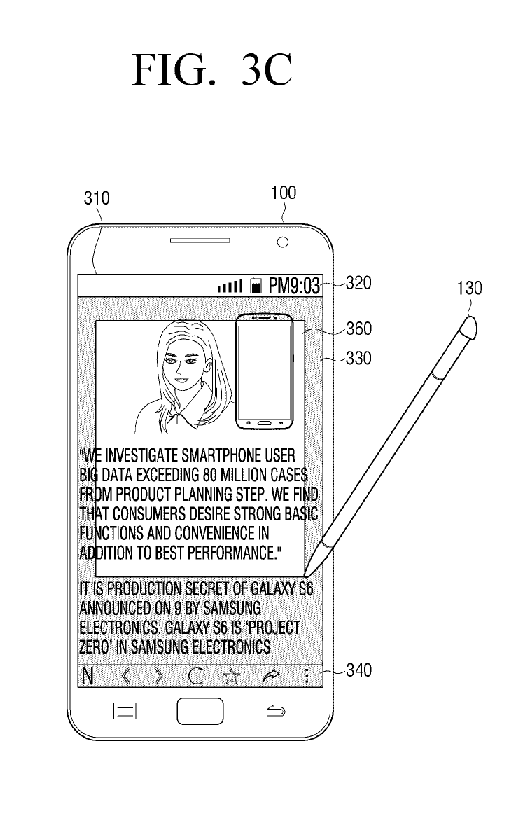

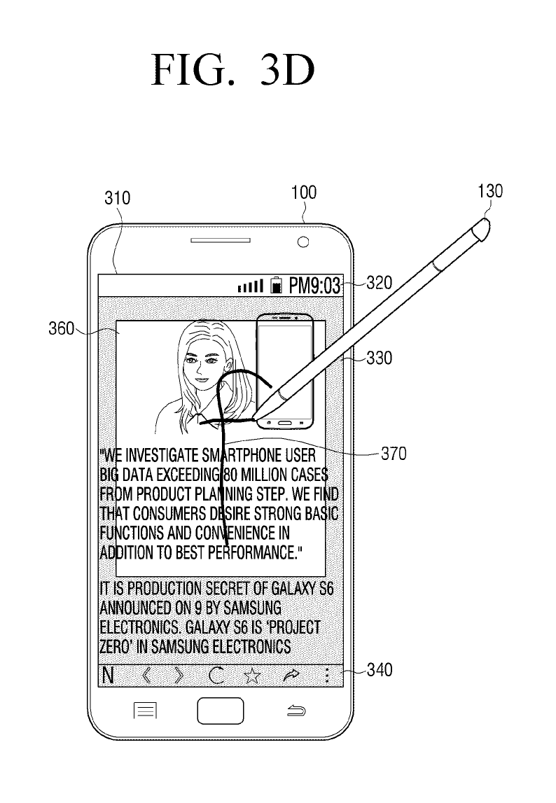

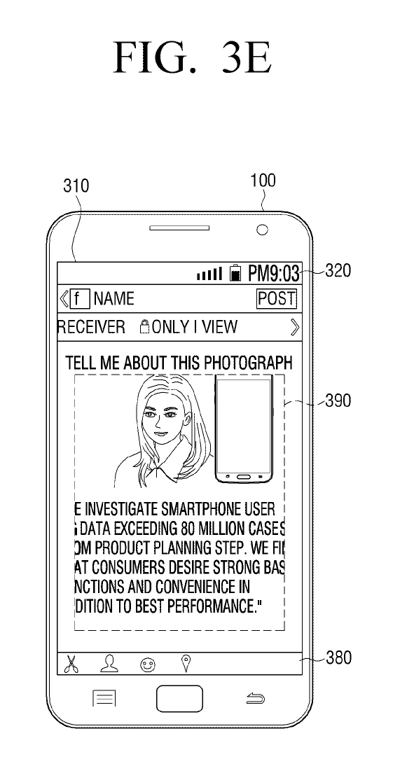

FIGS. 3A to 3E are views for describing an operation of posting a content on a social network service (SNS) according to an exemplary embodiment of the present disclosure.

Referring to FIG. 3A, the user terminal device 100 displays a screen 310 on the touch display. The screen 310 includes an upper fixed region and the remaining text regions 330 and 340.

The fixed region 320 displays several states and information of the user terminal device 100. For example, at least one of a thumbnail of an application that is being executed, a kind of activated communication, a strength of a sensed communication signal, a stage of charge (SoC) of a battery, and a current time may be displayed on the fixed region 320. The fixed region 320 may fixedly display a real time state of the user terminal device 100 on an upper end thereof except for display having a special authority such as full screen display.

A screen of an application executed in the user terminal device 100 is displayed on the text regions 330 and 340. Currently, the user terminal device 100 is executing an application N providing a portal service. The application N may provide a user interface (UI) 340 including a button moving to the previous page or the subsequent page of a currently displayed page of a portal site, a refresh button, a bookmark button, a sharing button, and the like, to a lower end of the screen.

An article for Galaxy s6™, which is a smartphone of Samsung Electronics™, is displayed on the remaining text region 330. The user may perform a touch input scrolling up and down the article to view an article content.

The user may perform a touch input using the stylus pen 130 to browse web pages of the portal site.

Referring to FIG. 3B, the user selects a partial region of the test region 330 in which the article is displayed. To select the partial region, the user holds the stylus pen 130, and then performs a manipulation of dragging the stylus pen 130 in a diagonal direction.

In an exemplary embodiment of FIG. 3, a region is selected using a rectangle having a start point and an end point of the drag as two vertices in the diagonal direction, but is not limited thereto. The selected region may be a region included in a circle extended depending on a drag displacement rather than the rectangle. As another exemplary embodiment, the selected region may be a region included in a closed curve freely drawn by the user.

Referring to FIG. 3C, the user terminal device 100 displays a screen 310 on which a partial region is selected on the text region 330 on which the article is displayed. In detail, the user terminal device 100 sets a rectangular region 360 surrounded by a coordinate at which a touch starts and a coordinate at which the touch is released at the time of performing a drag manipulation in the diagonal direction to the selected region. In addition, the user terminal device 100 darkly displays the remainder of the text regions 330 and 340 so that the selected region may be visually distinguished.

In an exemplary embodiment of FIG. 3, the selected region and a region that is not selected are distinguished from each other on the screen through shadowing, but are not limited thereto. The selected region may be displayed as a boundary of a dotted line or a solid line. Alternatively, the selected region may be displayed so that a transparent layer having a color overlaps the selected region on the selected region.

Referring to FIG. 3D, the user terminal device 100 receives a touch gesture in a state in which a partial region 360 of the screen 310 is selected. The user terminal device 100 displays a position that the stylus pen 130 touches on the text regions 330 and 340 to overlap the text regions 330 and 340. In FIG. 3D, the user terminal device 100 displays a touch gesture 370 having an alphabet ‘f’ form on the screen 310. The user terminal device 100 recognizes a pattern of the touch gesture 370, and executes a function of an application corresponding to the recognized pattern. In addition, the user terminal device 100 extracts a content from the selected region 360.

Referring to FIG. 3E, the user terminal device 100 displays a screen 310 in which the content is inserted into the application. In detail, the user terminal device 100 displays the screen 310 in which an ‘f’ application, which is a social media, is executed. A fixed region 320, a UI region 380 in which buttons of functions provided by the ‘f’ application are arranged, and a region in which a content to be posted may be input are included in the screen 310.

The user terminal device 100 inserts a screen shot image 390 obtained by capturing the selected region 360 into the region in which the content to be posted is input. In an exemplary embodiment of FIG. 3, the screen shot image 390 is inserted, but at least one of an image quoted in the article or a text of the article may be inserted. In the case in which the ‘f’ application may post only the text, the user terminal device 100 may extract only the text of the article and then insert the extracted text as a post. In addition, the user terminal device 100 may insert a source of the article as a post.

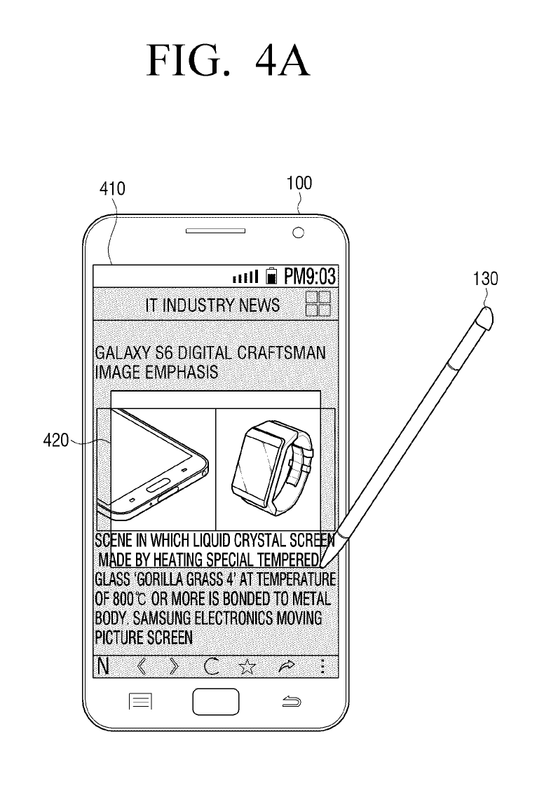

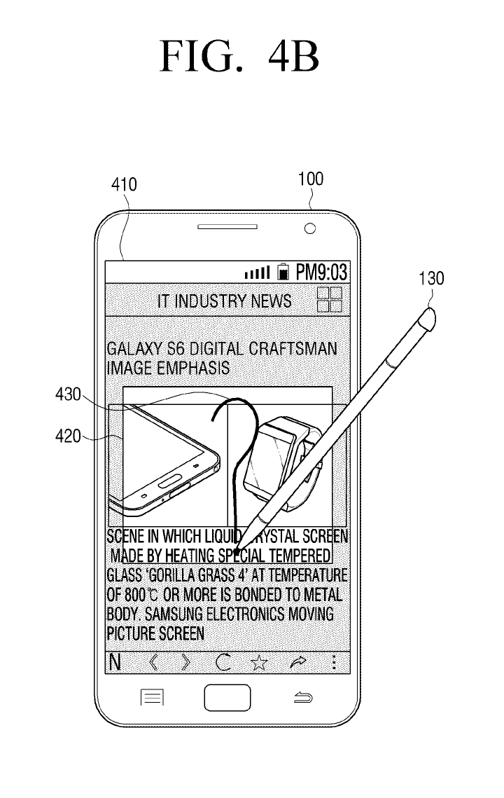

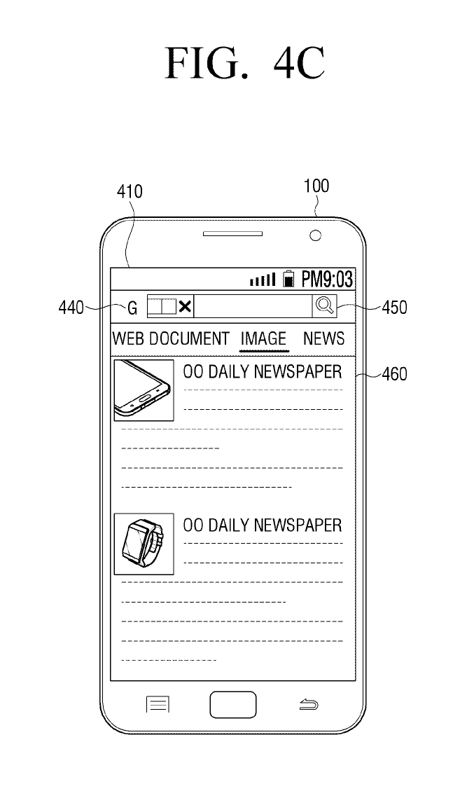

FIGS. 4A to 4C are views for describing an operation of searching a content according to an exemplary embodiment of the present disclosure.

Referring to FIG. 4A, the user terminal device 100 displays a screen 410 on which a partial region 420 is selected on a region on which an article is displayed. A method of selecting the partial region and the screen 410 on which the partial region is selected are similar to the screen 310 of FIG. 3, and an overlapping description therefor will thus be omitted.

Referring to FIG. 4B, the user terminal device 100 receives a touch gesture. The user terminal device 100 visually displays a touch point 430 of the received touch gesture. In FIG. 4B, the user terminal device 100 receives a touch gesture having a ‘?’ form. The user terminal device 100 decides that a pattern of the received touch gesture is a ‘?’ pattern. In addition, the user terminal device 100 executes a function of an application corresponding to the touch gesture. In an exemplary embodiment of FIG. 4, the user terminal device 100 executes an application performing a search function. In detail, the user terminal device 100 may execute a dedicated application having the search function or execute a web browser for accessing a server providing a search.

Referring to FIG. 4C, the user terminal device 100 displays a result screen 410 obtained by performing the search function using a content of the selected region 420. The screen 410 includes a fixed region, a search interface region 440, a search window 450, a search result region 460.

The user terminal device 100 inputs the content included in the selected region 420 to the application. In detail, the user terminal device 100 may input an image and a text of an article included in the selected region 420 to the search window 450 for a search. In FIG. 4C, the user terminal device 100 displays a result 460 obtained by performing an image search using the image of the article.

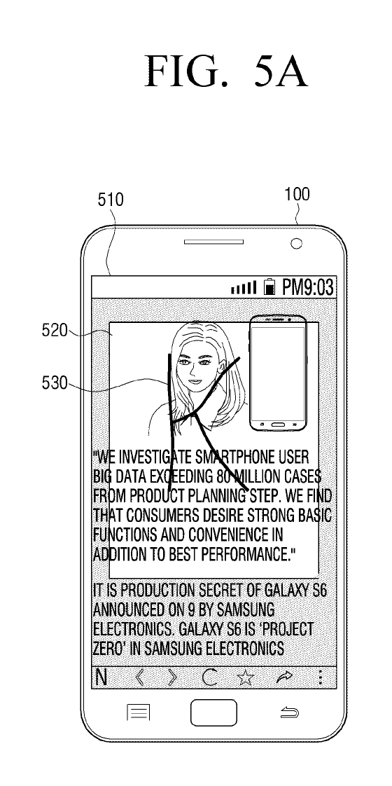

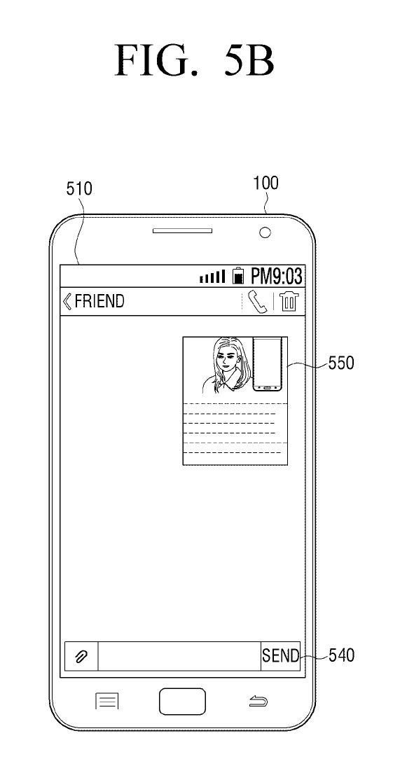

FIGS. 5A and 5B are views for describing an operation of transmitting a content by a messenger according to an exemplary embodiment of the present disclosure.

Referring to FIG. 5A, the user terminal device 100 displays an article for a Galaxy s6™ product of Samsung Electronics™. In addition, the user terminal device 100 receives a touch gesture 530 having a pattern ‘K’ in a state in which a partial region 520 of a screen 510 on which the article is displayed is selected. The user terminal device 100 decides a predetermined ‘K’ pattern, and executes a function of an application corresponding to the decided pattern. In an exemplary embodiment of FIG. 5, the user terminal device 100 executes a messenger application.

Referring to FIG. 5B, the user terminal device 100 displays a screen 510 in which a content transmission function is performed through a messenger. In detail, the user terminal device 100 executes the messenger application corresponding to the received touch gesture 530, and inputs a content 550 included in the selected region 520 to an input blank 540 for transmitting a message. In FIG. 5B, a form in which the user terminal device 100 inputs the content 550 to the input blank 540 and completes the transmission of the message is illustrated. In another exemplary embodiment, the user terminal device 100 may transmit an address of a web page in which an article that is to be notified to the other party by a message is distributed, together with a headline of the article.

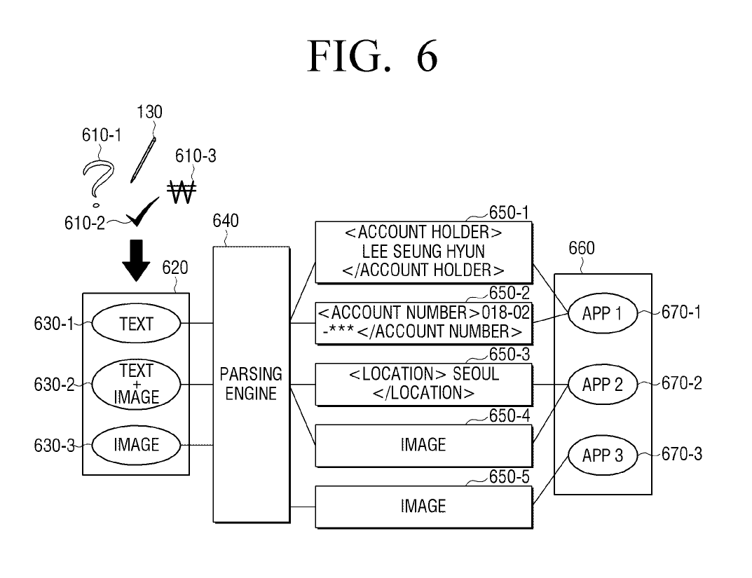

FIG. 6 is a view for describing a content selecting method according to an exemplary embodiment of the present disclosure.

Referring to FIG. 6, a plurality of touch gestures 610-1, 610-2, and 610-3 having predetermined patterns are input to the user terminal device of which a partial region is selected by the stylus pen 130.

A content domain 620 is a set of contents that may be included in the selected region. The content domain 620 includes a content 630-1 in which only a text exists, a content 630-3 in which only an image exists, and a content 630-2 in which a text and an image coexist with each other.

The contents 630-1, 630-2, and 630-3 are input to a parsing engine 640. The parsing engine 640 parses the contents 630-1, 630-2, and 630-3. The parsing engine 640 parses the contents 630-1, 630-2, and 630-3 on the basis of a type of contents. The parsing engine 640 may separate the content 630-2 including the text and the image into a text type content and an image type content. The parsing engine 640 may separate the content on the basis of a meaning of a word, a description manner, a structure of a sentence, and the like, in the text type content. For example, the parsing engine 640 may separate a content indicating a time on the basis of a dictionary meaning. The parsing engine 640 may separate a content indicating an account number on the basis of the number of numerals and a description manner in which a hyphen is inserted. The parsing engine 640 may separate corpora based on a relationship and an arranging sequence of a sentence of the subject, the object, and the predicate. In this case, the parsing engine may insert a tag so that the separated information may be identified. The respective parsed information 650-1, 650-2, 650-3, 650-4, and 650-5 as described above is called tokens. The tokens 650-1, 650-2, 650-3, 650-4, and 650-5 are transferred to an application domain 660. Applications 670-1, 670-2, and 670-3 matched to the touch gestures 610-1, 610-2, and 610-3 having the predetermined patterns are included in the application domain 660. A token 650-1 indicating an account holder and a token 650-2 indicating an account number are input to application 1 670-1 in which a name and the account number of the account holder are required. A token 650-4 containing a photograph and a token 650-3 indicating a location of the photograph are input to album application 2 670-2. A token 650-5 indicates an image recognizing a human face through image processing from a screen shot image obtained by capturing an output screen and separating the human face. The token 650-5 may be input to application 3 670-3 synthesizing the photograph.

In the process of parsing the content as described above, information required or appropriate for executing the function of the application may be selected and input.

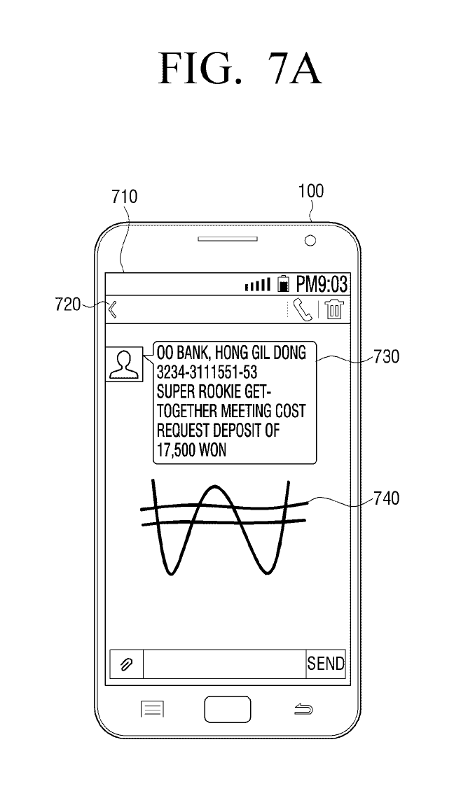

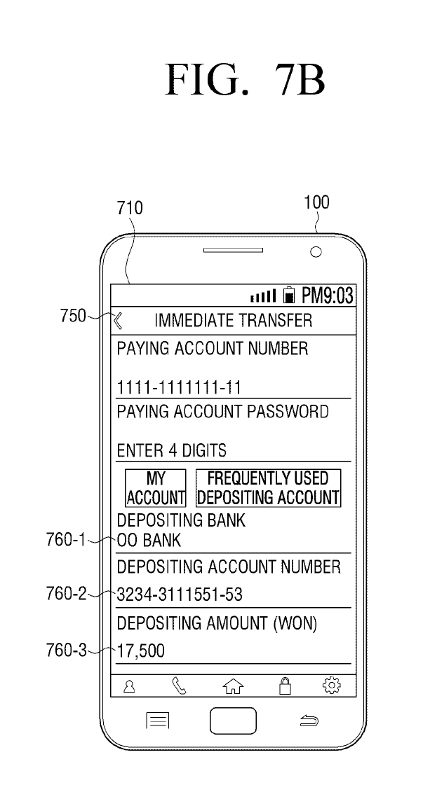

FIGS. 7A and 7B are views for describing an example of inputting portions of a content to an application according to an exemplary embodiment of the present disclosure.

Referring to FIG. 7A, the user terminal device 100 displays a screen 710 in which a messenger application is executed. The messenger application provides a graphic interface including symbols indicating specific functions, an input blank to which a message may be input, and the like.

A message 730 received from the other party is displayed on the screen 710. Information on a bank name, an account holder, and an account number indicating an account to be deposited is described in a text type together with a content requesting deposit of a get-together meeting cost in the message 730.

The user terminal device 100 receives a touch gesture 740 having a ‘W’ pattern. A touch point of the received touch gesture 740 is displayed on the screen 710.

Meanwhile, an exemplary embodiment of FIG. 7 is a state in which a partial region is not selected on the screen 710 of the user terminal device 100. When the predetermined pattern 740 is directly received on the screen of the user terminal device 100 in this state, the user terminal device 100 may designate the entire screen 710 as a selected region.

The user terminal device 100 executes a deposit transfer function of a bank application corresponding to the ‘W’ pattern.

Referring to FIG. 7B, the user terminal device 100 displays a screen 710 in which the corresponding bank application is executed. The screen 710 includes an interface 750 for a remitting function of the executed bank application and contents 760-1, 760-2, and 760-3 input to various input blanks.

The user terminal device 100 fills the respective input blanks of the bank application. In detail, the user terminal device 100 may input a paying account number of a pre-stored account that the user frequently uses. The user terminal device 100 extracts a depositing bank, a depositing account number, and a depositing amount required for the remitting function from a message 760 of a selected region 710. According to an exemplary embodiment of FIG. 6, the message 760 may be parsed into a bank name token, an account number token, a depositing amount token. In addition, information on the parsed tokens may be input to input blanks to which the depositing bank, the depositing account number, and the depositing amount are input. OO bank 760-1, 3234-3111551-53 760-2, and 17,500 760-3 included in the received message are input to the input blanks to which the depositing bank, the depositing account number, and the depositing amount are input.

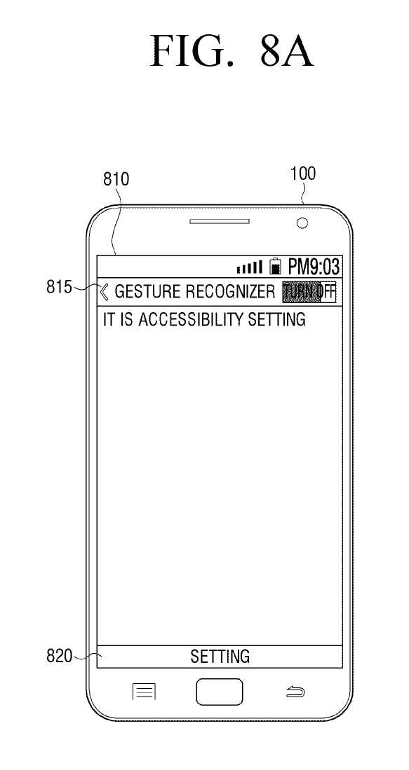

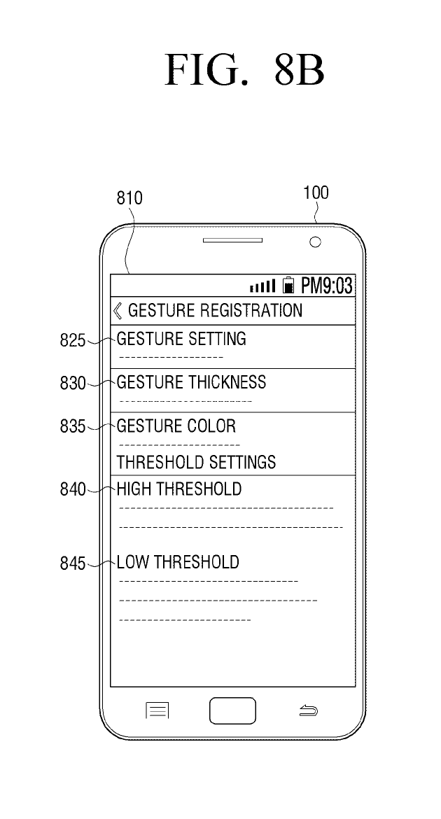

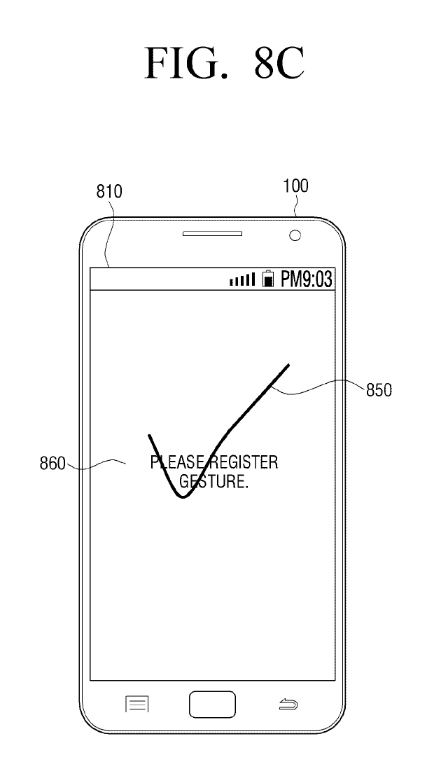

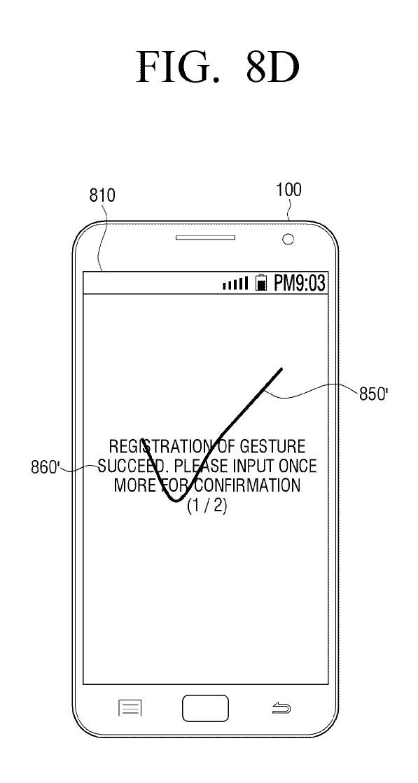

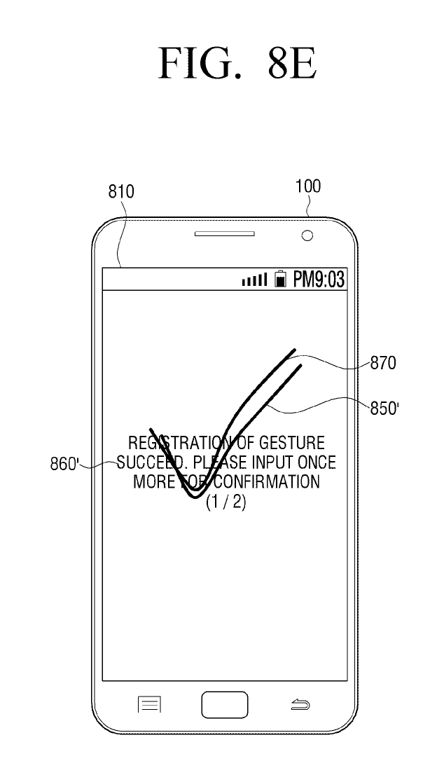

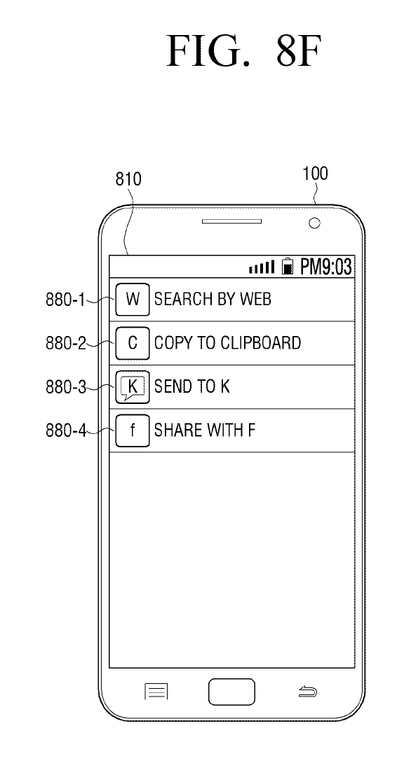

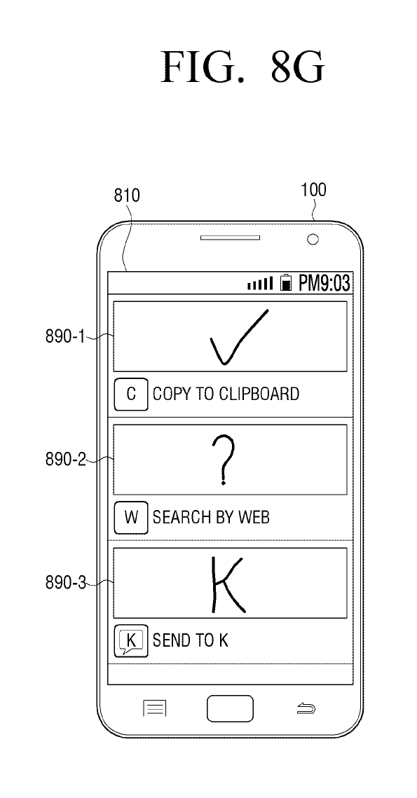

FIGS. 8A to 8G are views illustrating a set screen according to an exemplary embodiment of the present disclosure.

Referring to FIG. 8A, the user terminal device 100 displays a screen 810 in which a touch gesture may be set. An interface 815 for setting the touch gesture may include a button for activating or inactivating a touch gesture function and a setting button 820 for detailed setting. When the setting button 820 is selected, the user terminal device 100 displays a screen 810 of FIG. 8B.

Referring to FIG. 8B, a gesture registering interface includes a gesture setting item 825 for registering a new touch gesture, a gesture thickness item 830 for setting a thickness of a stroke of the touch gesture displayed on the screen, a gesture color item 835 for setting a color of the touch gesture displayed on the screen, a high threshold item 840 for setting similarity between a first input gesture and a second input gesture at the time of registering the new touch gesture to be high, and a low threshold item 845 for setting similarity between the newly registered gesture and other gestures. Here, as the similarity of the high threshold item 840 is set to be high, the second input gesture after the first gesture is input needs to be precisely input. In addition, as the similarity of the low threshold item 845 is set to be low, an upper limit level of patterns of the newly registered touch gesture for the existing registered gestures needs to be large. When the gesture setting item 825 for registering the new touch gesture is selected, the user terminal device 100 displays a screen 810 of FIG. 8C.

Referring to FIG. 8C, the user terminal device 100 displays a screen 810 for receiving a touch gesture 850 having a new pattern. In detail, the user terminal device 100 displays a notice 860 for registration on a base on which a gesture may be drawn. In an exemplary embodiment of FIG. 8, a new touch gesture 850 has a ‘V’ pattern. When a predetermined time elapses after the new gesture 850 is input, the user terminal device 100 displays a screen 810 of FIG. 8D.

Referring to FIG. 8D, the user terminal device 100 displays a screen 810 for receiving a second touch gesture. In detail, the user terminal device 100 displays the previous gesture 850′ in which a color and a brightness of the first input gesture 850 are darkly changed and a notice 860′ for inputting a second gesture. The user terminal device 100 displaying a screen 810 in which a second gesture 870 having a ‘V’ pattern is input is illustrated in FIG. 8E. When it is decided that the second input touch gesture 870 has the same pattern as that of the first input gesture 850, the user terminal device 100 displays a screen 810 of FIG. 8F.

Referring to FIG. 8F, the user terminal device 100 displays a screen 810 including a list in which functions of applications are arranged. In detail, the user terminal device 100 displays a ‘search by web’ item 880-1 indicating a web search function, a ‘copy to clipboard’ item 880-2 indicating a function of copying data to a temporary storage region, a ‘send to K’ item 880-3 indicating a function of transmitting a content of a selected region by a messenger, and a ‘share with f’ item 880-4 indicating a function of posting the content of the selected region on a social media, together with application icons supporting the respective functions. The user terminal device 100 may display only functions that do not have corresponding touch gestures among functions supported by the user terminal device 100. When the ‘copy to clipboard’ item 880-2 is selected, the user terminal device 100 displays a screen 810 of FIG. 8G.

Referring to FIG. 8G, the user terminal device 100 displays a screen 810 including a list in which registered touch gestures and functions of applications corresponding to the registered touch gestures are arranged. In detail, the user terminal device 100 displays a first item 890-1 in which a touch gesture having a ‘V’ pattern and a ‘copy to clipboard’ function are matched to each other, a second item 890-2 in which a touch gesture having a ‘?’ pattern and a ‘search by web’ function are matched to each other, and a third item 890-3 in which a touch gesture having a ‘K’ pattern and a ‘send to K’ function are matched to each other.

The touch gestures for automatically executing the functions of the applications may be registered in the user terminal device through the user interfaces as described above.

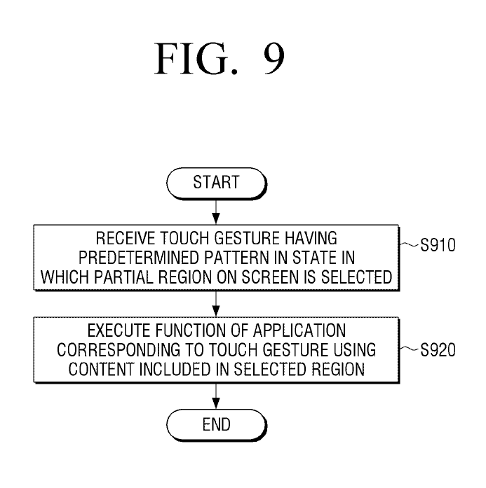

FIG. 9 is a flow chart for describing a control method for a user terminal device according to an exemplary embodiment of the present disclosure.

Referring to FIG. 9, a touch gesture having a predetermined pattern is received in a state in which a partial region on a screen is selected (S910). In detail, the user terminal device may receive an input for selecting the partial region on the screen before receiving the touch gesture. In detail, the user terminal device enters a state in which the partial region is selected by a user. Then, the user terminal device may receive a touch gesture depending on an existing registered pattern. In FIG. 910, the input for selecting the partial region and an input of the touch gesture may be performed by the stylus pen. In addition, the control method for a user terminal device may further include, before S910, storing the touch gesture and information on a function of an application corresponding to the touch gesture. The user terminal device may decide a pattern matched to the received touch gesture on the basis of the pre-stored information, and execute a function of an application corresponding to the matched pattern.

The pre-stored touch gesture may be a touch gesture registered by the user depending on the interface of FIG. 8. In an exemplary embodiment, the control method for a user terminal device may further include, before S910, displaying a user interface (UI) screen for registering a pattern; and matching a pattern input on the UI screen to a function of an application selected by the user and storing the matched pattern.

Then, the function of the application corresponding to the touch gesture is executed using a content included in the selected region (S920). In detail, the user terminal device may decide the function of the application corresponding to the input touch gesture, and input a content extracted from the selected region to the application to execute the function of the application. The user terminal device may extract the content depending on the function of the application. In an exemplary embodiment, S920 may include deciding a type of content usable for executing the function of the application. The user terminal device may extract the content of the selected region on the basis of the decided type of content, and execute the function of the application using the extracted content.

In another exemplary embodiment, S920 may include extracting a content required for executing the function of the application among contents included in the selected region. The user terminal device may extract only the required content, and execute the function of the application corresponding to the touch gesture using the extracted content.

In still another exemplary embodiment, S920 may include analyzing an image included in the selected region to extract an object included in the image. The user terminal device may extract a specific target configuring the image, and input the extracted target as a content for executing the function of the application.

In the control method for a user terminal device as described above, information may be input and a desired function of the application may be executed, at a time only by a gesture input of the user in information on the screen that is being searched. In addition, the gesture input by the stylus pen 130 may extend usefulness of the stylus pen while giving the user a feeling as if the user draws a picture with the pen.

The control method for a user terminal device according to an exemplary embodiment as described above may be implemented in the user terminal device of FIG. 1 or FIG. 2. In addition, the control method for a user terminal device may also be implemented by program codes stored in various types of recording media and executed by a CPU, or the like.

In detail, the program codes for performing the control method for a user terminal device described above may be stored in various types of recording media that is readable by a terminal, such as a RAM, a flash memory, a ROM, an EPROM, an EEPROM, a register, a hard disk, a removable disk, a memory card, a USB memory, a CD ROM, and the like.

Meanwhile, although the case in which all the components configuring an exemplary embodiment of the present disclosure are combined with each other as one component or are combined and operated with each other has been described, the present disclosure is not necessarily limited to the exemplary embodiment. That is, all the components may also be selectively combined and operated with each other as one or more components without departing from the scope of the present disclosure. In addition, although each of all the components may be implemented by one independent hardware, some or all of the respective components which are selectively combined with each other may be implemented by a computer program having a program module performing some or all of functions combined with each other in one or plural hardware.

Codes and code segments configuring the computer program may be easily inferred by those skilled in the art to which the present disclosure pertains. The computer program may be stored in non-transitory computer readable medium and may be read and executed by a computer to implement an exemplary embodiment of the present disclosure.

Here, the non-transitory computer readable medium does not mean a medium storing data for a while, such as a register, a cache, a memory, or the like, but means a medium semi-permanently storing data and readable by an apparatus. In detail, the programs described above may be stored and provided in the non-transitory computer readable medium such as a CD, a digital versatile disk (DVD), a hard disk, a Blu-ray disk, a USB, a memory card, a ROM, or the like.

Although exemplary embodiments of the present disclosure have been illustrated and described, the present disclosure is not limited to the abovementioned specific exemplary embodiments, but may be variously modified by those skilled in the art to which the present disclosure pertains without departing from the spirit and scope of the present disclosure as claimed in the claims. In addition, such modifications should also be understood to fall within the scope of the present disclosure.

### INDUSTRIAL APPLICABILITY

### Sequence List Free Text

1. A user terminal device comprising:
a touch display configured to display a screen; and
a controller configured to execute a function of an application corresponding to a touch gesture having a predetermined pattern using a content included in a selected region when the touch gesture is received in a state in which a partial region on the screen is selected.

2. The user terminal device as claimed in claim 1, wherein the selection for the partial region and the touch gesture are performed by a stylus pen.

3. The user terminal device as claimed in claim 1, wherein a type of the content includes at least one of an image and a text included in the selected region.

4. The user terminal device as claimed in claim 1, wherein the controller decides a type of content usable for executing the function of the application, extracts the decided type of content from the selected region, and executes the function of the application corresponding to the touch gesture using the extracted content.

5. The user terminal device as claimed in claim 1, wherein the controller extracts a content required for executing the function of the application among contents included in the selected region and executes the function of the application corresponding to the touch gesture using the extracted content.

6. The user terminal device as claimed in claim 1, wherein the controller analyzes an image included in the selected region to extract an object included in the image, and executes the function of the application corresponding to the touch gesture using the extracted object.

7. The user terminal device as claimed in claim 1, further comprising a storage configured to store a plurality of patterns and information on functions of applications corresponding to each of the plurality of patterns,
wherein the controller decides a pattern matched to the received touch gesture among the plurality of patterns and executes a function of an application corresponding to the matched pattern using the content.

8. The user terminal device as claimed in claim 7, wherein the controller displays a user interface (UI) screen for registering a pattern, matches a pattern input on the UI screen to a function of an application selected by a user, and stores the matched pattern in the storage.

9. A control method for a user terminal device including a touch display displaying a screen, comprising:
receiving a touch gesture having a predetermined pattern in a state in which a partial region on the screen is selected; and
executing a function of an application corresponding to the touch gesture using a content included in the selected region.

10. The control method as claimed in claim 9, wherein the selection for the partial region and the touch gesture are performed by a stylus pen.

11. The control method as claimed in claim 9, wherein a type of the content includes at least one of an image and a text included in the selected region.

12. The control method as claimed in claim 9, wherein the executing includes:
deciding a type of content usable for executing the function of the application;
extracting the decided type of content from the selected region; and
executing the function of the application corresponding to the touch gesture using the extracted content.

13. The control method as claimed in claim 9, wherein the executing includes:
extracting a content required for executing the function of the application among contents included in the selected region; and
executing the function of the application corresponding to the touch gesture using the extracted content.

14. The control method as claimed in claim 9, wherein the executing includes:
analyzing an image included in the selected region to extract an object included in the image; and
executing the function of the application corresponding to the touch gesture using the extracted object.

15. The control method as claimed in claim 9, further comprising pre-storing a plurality of patterns and information on functions of applications corresponding to each of the plurality of patterns,
wherein the executing includes:
deciding a pattern matched to the received touch gesture among the plurality of patterns; and
executing a function of an application corresponding to the matched pattern using the content.
